(19) United States
(12) Patent Application Publication
(10) Pub. No.: US 2026/0307188 A1
(43) Pub. Date: Oct. 8, 2026

(54) MACHINING CENTER FOR THE MECHANICAL PROCESSING OF WORKPIECES

(71) Applicant: MG Beteiligungsgesellschaft mbH, Geislingen/Steige (DE)

(72) Inventor: Magnus GRÜNER, Geislingen/Steige (DE)

(21) Appl. No.: 19/636,557

(22) Filed: Apr. 1, 2026

(30) Foreign Application Priority Data
Apr. 2, 2025 (EP) 25168041

(51) Int. Cl. B23Q 1/48; B23Q 3/06; B23Q 3/10

(52) U.S. Cl. CPC B23Q 1/48; B23Q 3/06; B23Q 3/103

(57) ABSTRACT

A machining center including a processing unit, which has a tool slide that can be equipped with a machining tool for machining a workpiece, and a workpiece positioning unit that can be equipped with a workpiece module. The tool slide is movable in one axis direction and the workpiece positioning unit is movable in the two other axis directions of a Cartesian coordinate system formed by three mutually perpendicular axis directions. The workpiece module is rotatable about a first axis of rotation. The interface device has a workpiece-positioning-side interface and a corresponding module-side counter-interface, where a fastening device for fastening the workpiece positioning unit and the workpiece module to each other is formed on the interface and the counter-interface, and a fluid transfer device for transferring a working fluid from the workpiece positioning unit to the workpiece module, an electric power transmission device and a signal transfer device.

### CROSS REFERENCE TO RELATED APLICATIONS

This application claims priority to European Patent Application No. 25168041.9 filed on Apr. 2, 2025, which is incorporated reference.

### BACKGROUND

The invention relates to a machining center for the mechanical machining of workpieces, comprising at least one processing unit, which has a tool slide that can be equipped with a machining tool for machining a workpiece arranged in a machining zone, and a workpiece positioning unit that can be equipped with a workpiece module for receiving the workpiece to be machined, wherein the tool slide is movable in one axis direction and the workpiece positioning unit is movable in the two other axis directions of a Cartesian coordinate system formed by three mutually perpendicular axis directions X, Y, Z, and wherein the workpiece module is rotatable about a first axis of rotation, wherein the workpiece module is releasably connected to the workpiece positioning unit via an interface device, allowing for an exchange of the workpiece module, wherein the interface device has a workpiece-positioning-side interface and a corresponding module-side counter-interface, wherein a fastening device for fastening the workpiece positioning unit and the workpiece module to each other is formed on the interface and the counter-interface, and wherein a fluid transfer device for transferring a working fluid from the workpiece positioning unit to the workpiece module is formed on the interface and the counter-interface.

A machining center of this type is known, for example, from DE 10 2019 120 681 A1. The machine tool disclosed therein has a tool spindle and a workpiece holder arranged on a carrier, wherein the carrier is movable via several drive arrangements or machine axes in several linear and rotary degrees of freedom. The tool spindle is preferably movable only in a single degree of freedom via a first linear drive arrangement. By means of a first rotary drive arrangement, the carrier can be pivoted between a working position and a changeover position about a first axis of rotation. The first axis of rotation extends in a vertical plane obliquely to the vertical and obliquely to the horizontal. The machine tool is designed for 4-axis machining of workpieces.

### SUMMARY

The object of the invention is to provide a machining center of the type mentioned at the outset, with which the productivity of the machining center can be increased compared to conventional machining centers.

This object is achieved by a machining center with the features of independent claims 1 and 14. Further developments of the invention are shown in the subclaims.

The inventive machining center according to independent claim 1 is characterized in that an electric power transmission device for transferring electric power from the workpiece positioning unit to the workpiece module and a signal transfer device for enabling signal transmission between the workpiece positioning unit and the workpiece module are formed on the interface and the counter-interface.

Thus, with the interface device, not only is mechanical fastening of the workpiece module to the workpiece positioning unit realized and a working fluid transferred, as in the prior art, but in addition, electric power can be transferred and signal transmission between the workpiece module and the workpiece positioning unit can also take place. This makes it possible that, if required, the workpiece module can be relatively easily replaced by another of similar design or can also be replaced by a workpiece module that differs in design and has additional functions compared to the standard workpiece module, which require the introduction of electric power and signal transmission. This makes it possible that a wide variety of workpieces with a wide variety of machining requirements can be machined with a single machining center by exchanging or replacing a workpiece module individually adapted to the workpiece to be machined via the interface device.

In a particularly preferred manner, the workpiece module is configured as a clamping device workpiece module for receiving and clamping the workpiece to be machined, wherein the clamping device has clamping elements, actuatable by means of the working fluid transferred via the interface device, in particular hydraulic fluid, for clamping the workpiece. Such a clamping device workpiece module could also be referred to as a 4-axis module, wherein there is no need here to introduce electric power into the clamping device workpiece module. However, it is also necessary here to be able to exchange the clamping device workpiece modules, since, depending on the workpiece to be machined, clamping is performed differently, i.e., the clamping elements have an arrangement individually adapted to the workpiece to be machined.

Alternatively to the clamping device workpiece module, the workpiece module can also be configured as a rotary table workpiece module, with at least one rotary table, rotatable by means of an electric rotary drive about a second axis of rotation, in particular NC-controlled, to which a clamping unit for receiving and clamping a workpiece to be machined can be fastened, wherein the electric rotary drive is on board the rotary table workpiece module and the electric power for the rotary drive can be introduced via the interface device. Such a rotary table workpiece module can also be referred to as a 5-axis workpiece module.

With such a configuration, it is thus possible to convert the machining center from 4-axis machining to 5-axis machining without requiring complicated conversion work, but merely requiring an exchange of the clamping device workpiece module at the interface device by a rotary table workpiece module.

It is possible that the rotary table workpiece module is configured as a simple rotary table workpiece module with a single rotary table. In addition, it is also conceivable that the workpiece module has an additional, further second rotary table, which is rotatable about a third axis of rotation, in particular aligned parallel to the second axis of rotation, to which a further clamping unit for receiving and clamping a workpiece to be machined can be fastened. Such a rotary table workpiece module could also be referred to as a double 5-axis module.

In the case of the workpiece module being configured as a double rotary table workpiece module, the rotary drive is expediently configured to drive both rotary tables.

In a further development of the invention, a position detection device for detecting the rotational position of the assigned rotary table is assigned to the workpiece module, wherein the position detection device has at least one position detector, in particular a position sensor, located on board the workpiece module, whose detector signals are transmitted via the interface device. The transmission can take place, for example, to a higher-level control unit, for example in the form of a control system, for example a CNC control. The position sensor can be designed, for example, as a rotary encoder.

In a further development of the invention, the fastening device has fastening elements formed on the interface and counter-fastening elements formed on the counter-interface, which can be brought into engagement with each other for fastening the workpiece module to the workpiece positioning unit and out of engagement with each other for releasing the workpiece module.

In a particularly preferred manner, the fastening elements and/or counter-fastening elements are mounted relatively movable to the associated interface or counter-interface via clamping means between a clamping position and a release position releasing the workpiece module. It is possible, for example, that the fastening elements or counter-fastening elements are designed as fluid-actuated clamping cones, which are moved into the clamping position when actuated by means of a working fluid. The working fluid can be, for example, hydraulic fluid, in particular hydraulic oil.

In a further development of the invention, the electric power transmission device is configured as an electromechanical plug connection device, with an electrical circular connector for plugging into an electrical counterpart and the electrical counterpart. It is possible, for example, that the circular connector is designed as a socket with female contacts, while the counterpart is designed with male counter-contacts, for example plug pins. It is possible that the circular connector is formed on the interface and the counterpart on the counter-interface. However, a reverse arrangement of the circular connector on the counter-interface and the counterpart on the interface is also possible.

In a further development of the invention, the signal transfer device is configured as a further electromechanical plug connection device, with an electrical signal circular connector for plugging into an electrical signal counterpart. Here too, the signal circular connector can be designed as a socket with female contacts and the signal counterpart with male counter-contacts, for example plug pins. Here too, it is expedient that the electrical signal circular connector is formed on the interface and the electrical signal counterpart on the counter-interface

In a further development of the invention, the interface is formed on the underside of a rotary table arranged on the workpiece positioning unit and rotationally drivable about the first axis of rotation. The end region of the rotary table equipped with the interface can be rectangular, preferably square, for this purpose.

In a further development of the invention, the counter-interface is formed on an, in particular, rectangular counter-interface plate. Such a counter-interface plate can also be referred to as a workpiece pallet. Alternatively, it is conceivable that the workpiece module is L-shaped and the counter-interface is formed on a plate-shaped counter-interface section, particularly in the case of a rotary table workpiece module.

The invention further comprises a machining center with the features of independent claim 14.

The inventive machining center according to claim 14 has at least one processing unit, which has a tool slide that can be equipped with a machining tool for machining a workpiece arranged in a machining zone, and a workpiece positioning unit that can be equipped with a workpiece module for receiving the workpiece to be machined, wherein the tool slide is movable in one axis direction and the workpiece positioning unit is movable in the two other axis directions of a Cartesian coordinate system formed by three mutually perpendicular axis directions X, Y, Z, and wherein the workpiece module is rotatable about a first axis of rotation, wherein the workpiece module is releasably connected to the workpiece positioning unit via an interface device, allowing for an exchange of the workpiece module, wherein the interface device has a workpiece-positioning-side interface and a corresponding module-side counter-interface, wherein the workpiece module is selected from the group consisting of a clamping device workpiece module having the counter-interface for receiving and clamping the workpiece, wherein the clamping device has clamping elements actuatable by means of working fluid for clamping the workpiece to be machined, and a rotary table workpiece module having the counter-interface, with at least one rotary table rotatable by means of an electric rotary drive about a second axis of rotation, to which a clamping unit for receiving and clamping a workpiece to be machined can be fastened, wherein optionally the clamping device workpiece module or the rotary table workpiece module can be fastened to the workpiece positioning unit via the interface device.

The assembly consisting of the clamping device workpiece module and the rotary table workpiece module thus allows for high flexibility, as the machining center can be converted from 4-axis machining to 5-axis machining and vice versa by simple measures.

In a further development of the invention, the rotary table workpiece module is either a simple rotary table workpiece module with a single rotary table or a double rotary table workpiece module with a first and a second rotary table rotationally drivable about a third axis of rotation.

### BRIEF DESCRIPTION OF THE DRAWINGS

A preferred embodiment of the invention is shown in the drawing and is explained in more detail below.

In the drawing:

FIG. 1 shows a side view of a part of the inventive machining center,

FIG. 2 shows an enlarged view of detail X from FIG. 1,

FIG. 3 shows a bottom view of the interface on the workpiece positioning unit of the machining center from FIG. 1,

FIG. 4 shows an alternative embodiment of the workpiece module in shape compared to the embodiment shown in FIG. 2,

FIG. 5 shows a perspective view of the workpiece module from FIG. 4,

FIG. 6 shows a perspective view of the workpiece module from FIG. 5 equipped with clamping units for receiving and holding workpieces (not shown) and

FIG. 7 shows a further alternative embodiment of the workpiece module in the form of a clamping device workpiece module.

### DETAILED DESCRIPTION

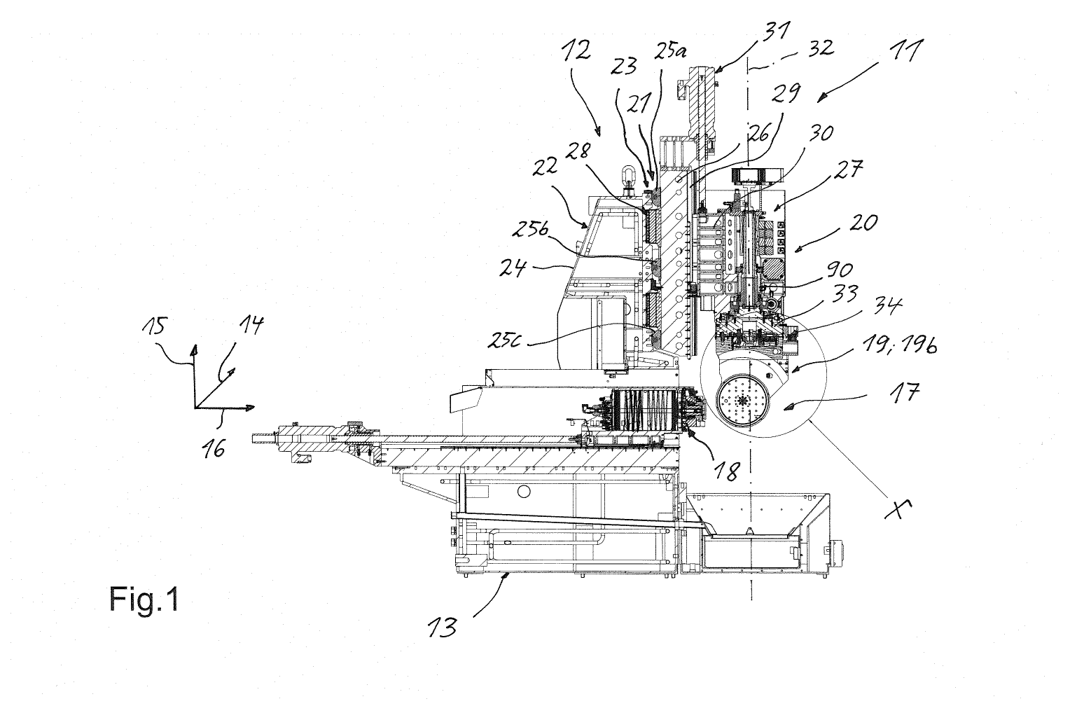

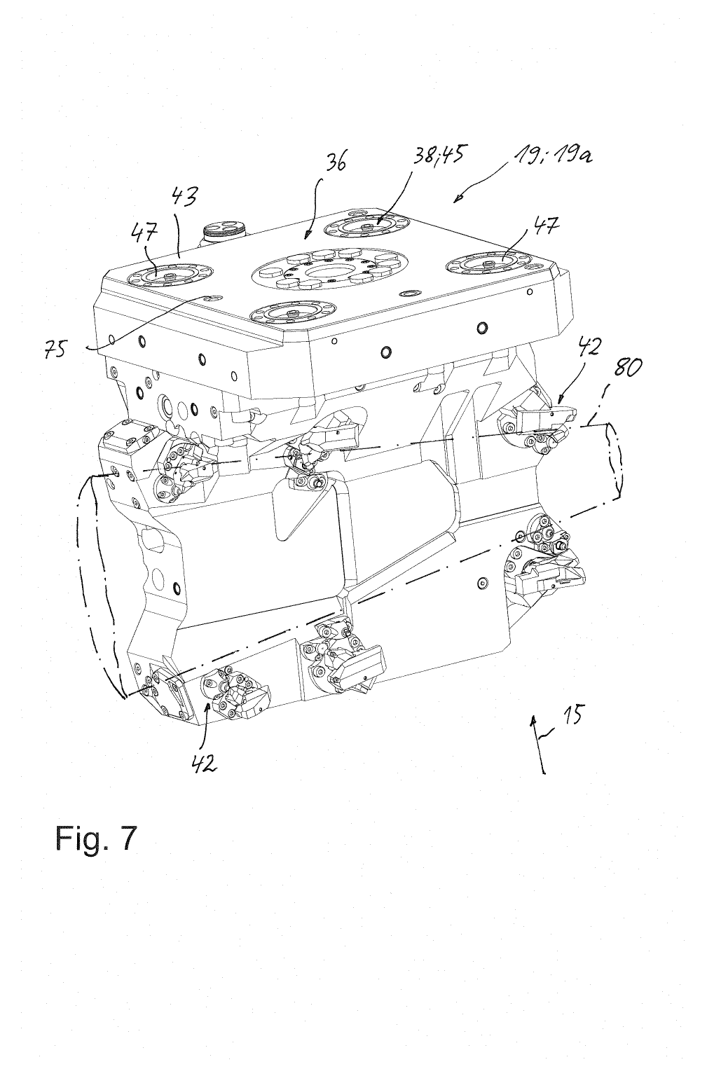

FIGS. 1-7 show a preferred embodiment of the inventive machining center 11 for mechanical, in particular chip-removing, machining of workpieces 80 (FIG. 7). The workpieces 80 can be, for example, gear housings, clutch housings, electric motor housings, or steering housings. However, this is only an exemplary list of the various types of workpieces 80. Other types of workpieces not mentioned here can also be machined with the inventive machining center 11.

The core of the machining center 11 is a processing unit 12. It is possible that the machining center 11 has a single processing unit 12 or, alternatively, two processing units (not shown), wherein the second processing unit can be arranged adjacent to the first processing unit in the X-axis direction 14 of a coordinate system formed by three mutually perpendicular axis directions X, Y, Z.

In the following, the invention will be described based on a machining center with a single processing unit 12, but the invention can of course also be applied to a machining center with two processing units.

The machining center 11 has a base frame 13 on which the processing unit 12 sits. The processing unit 12 has a tool slide 18 movable in the Z-axis direction 16 and equipped with a machining tool (not shown) for machining a workpiece arranged in a machining zone 17, and a workpiece positioning unit 20 movable in an X-axis direction 14 and in a Y-axis direction 15 and equipped with a workpiece module 19 for receiving and clamping the workpiece to be machined.

As shown in particular in FIG. 1, a guide device 21 is assigned to the processing unit 12 for the movement to be performed in the X-axis direction 14. The guide device 21 is located on a machine bed 22 arranged on the base frame 13, which in the present case is configured as a vertical bed. The machine bed 22 extends essentially over the entire width of the base frame 13 and has a front side 23 on which the guide device 21 is arranged. A rear side 24 is provided opposite the front side 23. The machine bed 22 separates the processing unit 12 into a workpiece-side front area, in which machining of workpieces 80 by the assigned machining tools takes place in the machining zone 17, and a rear, tool-side area, in which the handling of the machining tools takes place. The handling of the machining tools will not be discussed in more detail below.

Only the tool slide 18 moves back and forth between the rear, tool-side area and the front, workpiece-side area, while all other components remain on their respective sides.

The guide device 21, which could also be referred to as an X-guide device, is, as already mentioned above, arranged on the front side of the machine bed 22 and extends overall above the travel plane of the tool slide 18. This means that the workpiece positioning unit 20 hangs above the tool slide 18, so the workpiece to be machined is machined in a hanging position. The guide device 21 has several, in the exemplary case shown, three guide rails 25a, 25b, 25c, each of which is attached to the front side 23 of the machine bed 22 on the one hand and engages with the workpiece positioning unit (20) on the other hand.

The workpiece positioning unit 20 is, as already mentioned, guided linearly movable along the guide rails 25a-25c in the X-axis direction 14.

The workpiece positioning unit 20 has a cross slide 26 and a Y-slide 27 movably mounted on the cross slide 26a in the Y-axis direction 15.

For driving, an X-axis drive 28 is assigned to the workpiece positioning unit 20, which in the exemplary case shown is configured as a linear drive in the form of a linear motor.

In addition to the cross slide 26, the workpiece positioning unit 20 comprises the Y-slide. For this purpose, the cross slide 26 has a cross slide front wall arranged opposite the cross slide rear wall, on which at least one, in particular two Y-guide rails 29 extending in the Y-axis direction 15 are fastened.

As shown in particular in FIG. 1, the Y-slide 27 has a base body 30, which is coupled to the two Y-guide rails 29 such that it can be moved up and down in the Y-axis direction 15 by means of a Y-axis drive 31 arranged on board the workpiece positioning unit 20. The Y-axis drive 31 is configured as a linear drive, but in contrast to the X-axis drive, a linear drive in the form of a spindle drive is expediently used here.

The Y-slide 27 has a rotary table 33 rotatable about a first axis of rotation 32, which extends in the Y-axis direction 15, and mounted on the base body 30.

The rotational movement of the rotary table 33 is generated by a rotary drive 90 on board the Y-slide 27.

The rotational position of the rotary table 33 is detected and monitored by means of a rotary position measuring system.

An important aspect of the invention is that the workpiece module 19 described above is releasably connected to the workpiece positioning unit 20 via an interface device 34, allowing for an exchange of the workpiece module 19.

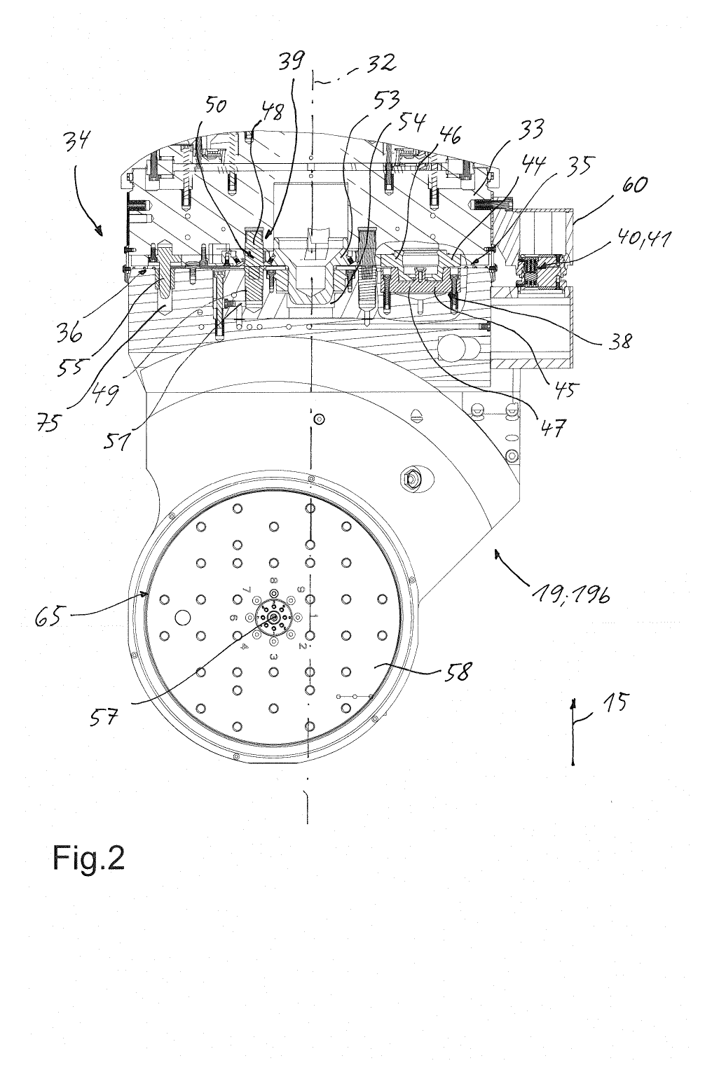

As shown in particular in FIG. 2, the interface device 34 has a workpiece-positioning-side interface 35 and a corresponding module-side counter-interface 36.

In the exemplary case shown, the interface 35 is formed on the underside of the rotary table 33. For example, the underside of the rotary table 33 equipped with the interface 35 can be rectangular, preferably square.

A fastening device 38 for fastening the workpiece positioning unit 20 and the workpiece module 19 to each other is formed on the interface 35 and the counter-interface 36. Furthermore, a fluid transfer device 39 for transferring a working fluid from the workpiece positioning unit 20 to the workpiece module 19 is formed on the interface 35 and the counter-interface 36.

Furthermore, an electric power transmission device 40 for transferring electric power from the workpiece positioning unit 20 to the workpiece module 19 is provided on the interface 35 and the counter-interface 36. Finally, a signal transfer device 41 for enabling signal transmission between the workpiece positioning unit 20 and the workpiece module 19 is formed on the interface 35 and the counter-interface 36.

FIGS. 2, 4, and 7 in particular show various embodiments of the workpiece module 19, which, as mentioned, has the counter-interface 36. The counter-interface 36 in the various workpiece modules 19, which will be discussed in more detail below, are designed identically to each other, so that optionally one of the workpiece modules 19 described below can be fastened to the interface 35 on the rotary table 33.

FIG. 7 shows a first embodiment of the workpiece module 19, which is hereinafter referred to as a clamping device workpiece module 19a. The clamping device workpiece module 19aserves to receive and clamp the workpiece to be machined, wherein it has clamping elements 42, actuatable by means of the working fluid, in particular hydraulic fluid, expediently hydraulic oil, transferred via the interface device 34, for clamping the workpiece 80 to be machined.

As shown in particular in FIG. 7, the clamping device workpiece module 19a has the counter-interface 36 formed corresponding to the interface 35 on the rotary table 33. In the exemplary case shown, the counter-interface 36 is formed on the top side of a counter-interface plate 43, which is formed corresponding to the, in particular, square interface 35 on the underside of the rotary table 33, so that the two, in particular, square interfaces 35 and counter-interfaces come to lie on top of each other during fastening.

The fastening device 38 already mentioned above has components formed on the interface 35 as well as components formed on the counter-interface 36.

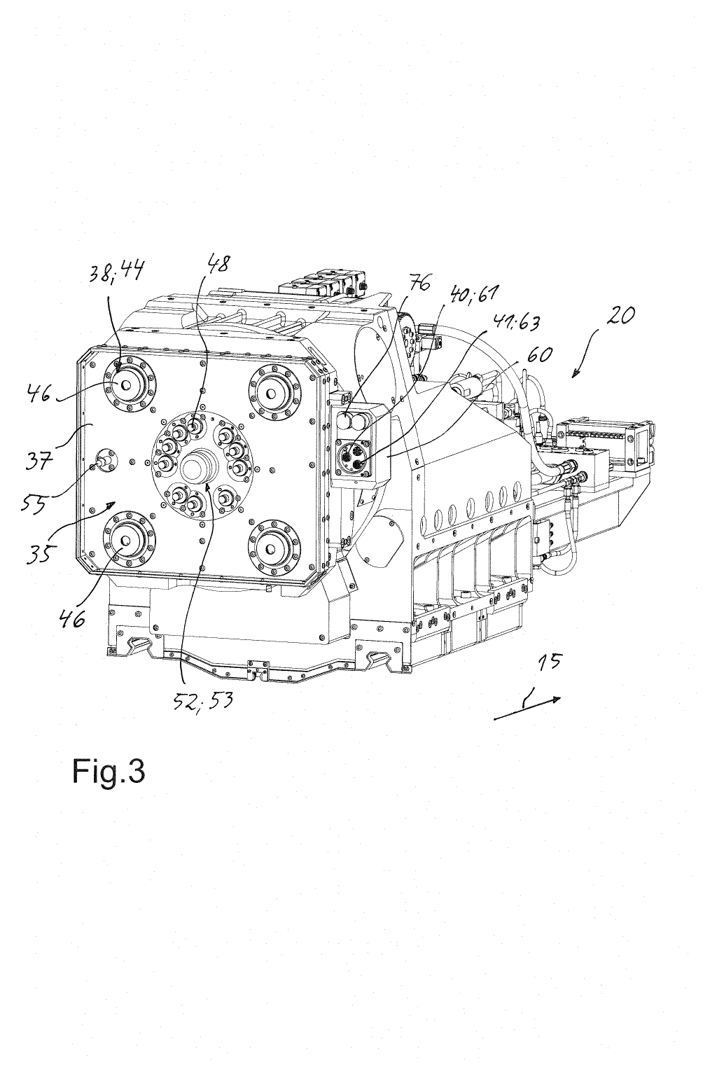

As shown in particular in FIGS. 3 and 7, the fastening device 38 has fastening elements 44 formed on the interface 35 and counter-fastening elements 45 formed on the counter-interface 36, which can be brought into engagement with each other for fastening the clamping device workpiece module 19a to the workpiece positioning unit 20 and out of engagement with each other for releasing the clamping device workpiece module 19a.

In the exemplary case shown, several fastening elements 44 are provided, which are expediently distributed circumferentially to each other on the interface 35. In the exemplary case shown of the rectangular cross-section of the interface 35, a fastening element 44 is located in each of the quadrants of the rectangular surface.

Corresponding to this, the counter-fastening elements 45 are arranged on the counter-interface 36, so it is also expedient here that a counter-fastening element 45 is arranged in each quadrant of the rectangular counter-interface.

In the embodiment shown, the fastening elements 44 are mounted relatively movable to the interface 35 via clamping means between a clamping position, in which the clamping device workpiece module 19a is clamped to the workpiece positioning unit 20, and a release position releasing the clamping device workpiece module 19a. The fastening elements 44 are expediently designed as piston elements, each having a clamping cone 46 that cooperates with a counter-fastening element 45 in the form of a counter-cone 47. The clamping cone 46 is movable by means of working fluid, in particular hydraulic fluid, between the release position and the clamping position, wherein a movement into the clamping position occurs by fluid actuation, in which the clamping cone 46 immerses into the counter-cone 47 and thus provides for clamping. The clamping process is performed synchronously for all fastening elements 44 and counter-fastening elements 45, so that simultaneous clamping and thus fastening of the clamping device workpiece module 19a to the workpiece positioning unit 20 takes place.

As shown in particular by the combination of FIGS. 2 and 3, the interface device 34 has a fluid transfer device 39 formed on the interface 35 and on the counter-interface 36. The fluid transfer between the workpiece positioning unit 20 and the workpiece module 19, for example the clamping device workpiece module 19a, takes place via a type of plug connection. For this purpose, in particular on the interface 35, several transfer pins 48 are arranged, which protrude outwards from the interface surface of the interface 35. The transfer pins 48 are assigned transfer openings 49, in particular in the form of circular cylindrical bores, on the counter-interface, into which the transfer pins 48 enter during the fastening process described above.

As shown in particular in FIG. 2, a workpiece-positioning-side fluid channel system 50 is connected to the transfer pins 48, through which working fluid, in particular hydraulic fluid, reaches the area of the transfer pins 48 if the fluid circuit is started. The transfer openings 49 in turn are connected to a module-side fluid channel system 51, whereby in the fastened operating position of the workpiece module 19, for example the clamping device workpiece module 19a, working fluid originating from the workpiece-positioning-side fluid channel system 50 reaches the transfer openings 49 via the transfer pins 48 and from there reaches the clamping elements 42 of the clamping device workpiece module 19 via the module-side fluid channel system 41, so that, if necessary, a clamping process can be initiated for a workpiece 80 to be clamped and machined on the clamping device workpiece module 19a.

As further shown by the combination of FIGS. 2 and 3, a centering device 52 is provided for centering the workpiece module, for example the clamping device workpiece module 19a, on the workpiece positioning unit 20, which means that the counter-interface 36 on the clamping device workpiece module 19a is precisely aligned with the interface 35 on the rotary table 33, so that the subsequent fastening process and the immersion of the transfer pins 48 into the transfer openings 49 can take place synchronously. For this purpose, the centering device 52 has a central centering mandrel 53 coaxial with a central axis of the Y-slide 27, whose diameter corresponds approximately to the diameter of the clamping cones 46 of the fastening elements 44. The centering mandrel 53 on the interface 35 is assigned a centering receptacle 54 formed on the counter-interface 36, into which the centering mandrel 53 can immerse ahead of the clamping cones.

The centering device 52 further includes an eccentrically arranged centering pin 55, which is arranged in particular on the interface 35 and protrudes outwards from the interface surface. The centering pin 55 is assigned a centering bore 75, in particular on the side of the counter-interface 36. Centering pin 55 and centering bore 75 ensure a precise alignment of the counter-interface 36 with the interface 35, whereby components on interface 35 and counter-interface, which only fit together in one orientation of the interface 35 to the counter-interface 36, can be precisely and accurately joined, in particular plugged together, such as, for example, the power transmission device 40 and the signal transfer device 41 described in more detail below.

As shown in particular by the combination of FIGS. 3 and 7, in the clamping device workpiece module 19a, there is only a need for a mechanical fastening of the clamping device workpiece module 19a to the workpiece positioning unit 20, whereby a rotational movement of the clamping device workpiece module 19 about the first axis of rotation 32 is possible. The clamping device workpiece module 19 allows 4-axis machining of workpieces. An additional power input and signal transfer between the clamping device workpiece module 19 and the workpiece positioning unit 20 is not necessary, so that the correspondingly designed connections on the interface 35 remain blind here.

As already mentioned, it is possible to attach a rotary table workpiece module 19b to the workpiece positioning unit 20 instead of the clamping device workpiece module 19a, making a simple conversion from 4-axis machining to 5-axis machining possible.

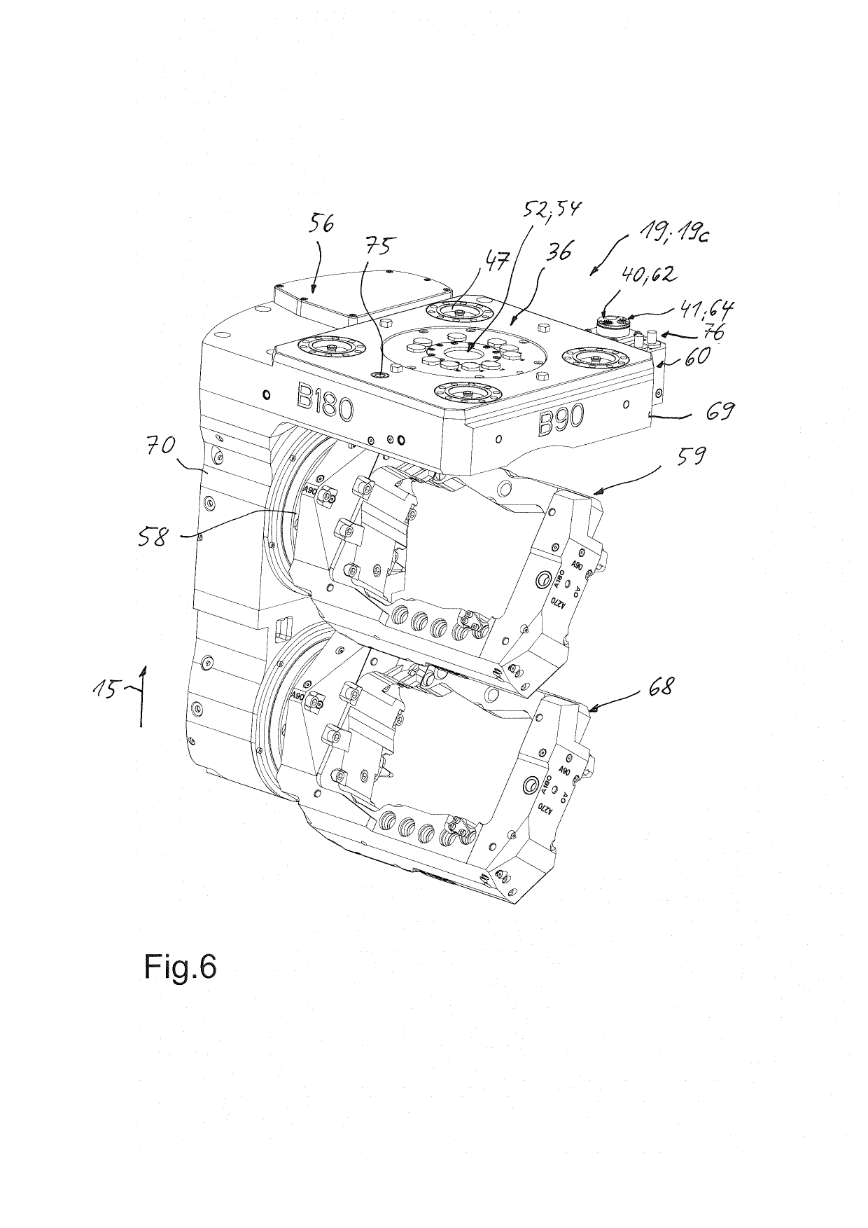

FIG. 2 shows an example of such a rotary table workpiece module 19b, which is designed here as a simple rotary table workpiece module 19. The rotary table workpiece module 19b in this case has a rotary table 58 rotatable about a second axis of rotation 57 by means of an electric rotary drive 56, which is in particular NC-controlled. On the rotary table 58, a clamping unit 59 for receiving and clamping a workpiece to be machined can be fastened, as shown, for example, in FIG. 6 for another embodiment of the rotary table workpiece module 19b.

The electric rotary drive 56 is on board the rotary table workpiece module 19b and requires electric power for this purpose, which is provided via the power transmission device 40 of the interface device 34, i.e., from the workpiece positioning unit 20 to the workpiece module.

Furthermore, a signal transfer device 41 for enabling signal transmission between the workpiece positioning unit 20 and the workpiece module 19, in particular the simple rotary table workpiece module 19b, is formed on the interface 35 and the counter-interface 36.

As shown in particular in FIG. 3, the electric power transmission device 40 is configured as an electromechanical plug connection device. The electromechanical plug connection device is expediently located laterally next to the interface 35 in a separate additional module, which is enclosed by a module housing 60. One housing half sits on the interface 35, i.e., on the periphery of the lower area of the rotary table 33, and the correspondingly designed other, in particular lower, housing half sits on the counter-interface plate 43.

The electromechanical plug connection device, hereinafter referred to as the electromechanical plug connection device, has at least one electrical circular connector 61 for plugging into an electrical counterpart 62, which is also part of the electromechanical plug connection device.

The electrical circular connector 61 is expediently designed as a socket with female contacts. Corresponding to this, the electrical counterpart 62 is equipped with male counter-contacts not shown, for example plug pins. The at least one circular connector 61 is expediently located on the interface 35 and the electrical counterpart 62 on the counter-interface 36.

As further shown by the combination of FIGS. 2 and 3, an additional fluid transfer device 76 can be formed on the interface 35 and the counter-interface 36. The additional fluid transfer device 76 can also be arranged, for example, in the area of the additional module next to the interface 35. The additional fluid can be, for example, compressed air, which is transferred for cleaning purposes from the workpiece positioning unit 20 to the workpiece module 19, for example the simple rotary table workpiece module 19b.

The signal transfer device 41 already mentioned is also expediently designed as an electromechanical plug connection device, which in this case is referred to as a further, second electromechanical plug connection device.

The second electromechanical plug connection device also has an electrical circular connector 63, hereinafter referred to as a signal circular connector 63. The electrical signal circular connector 63 serves for plugging into an electrical counterpart 64, hereinafter referred to as an electrical signal counterpart 64. The electrical signal circular connector 63 is expediently designed as a socket with female contacts, while the electrical signal counterpart 64 is designed with male counter-contacts, for example plug pins. Here too, it is expedient that the electrical signal circular connector 63 is formed on the interface 35 and the electrical signal counterpart 64 on the counter-interface 36.

The signal transfer device 41 is required because the workpiece module 19, for example the simple rotary table workpiece module 19b, is assigned a position detection device 65 for detecting the rotational position of the assigned rotary table 58.

Although not shown in the figures, the position detection device can have at least one position detector located on board the workpiece module, i.e., the simple rotary table workpiece module 19b, whose detector signals are transmitted via the interface device 34 in particular to a higher-level control unit. The position detector can be designed, for example, as a position sensor, in particular a rotary encoder.

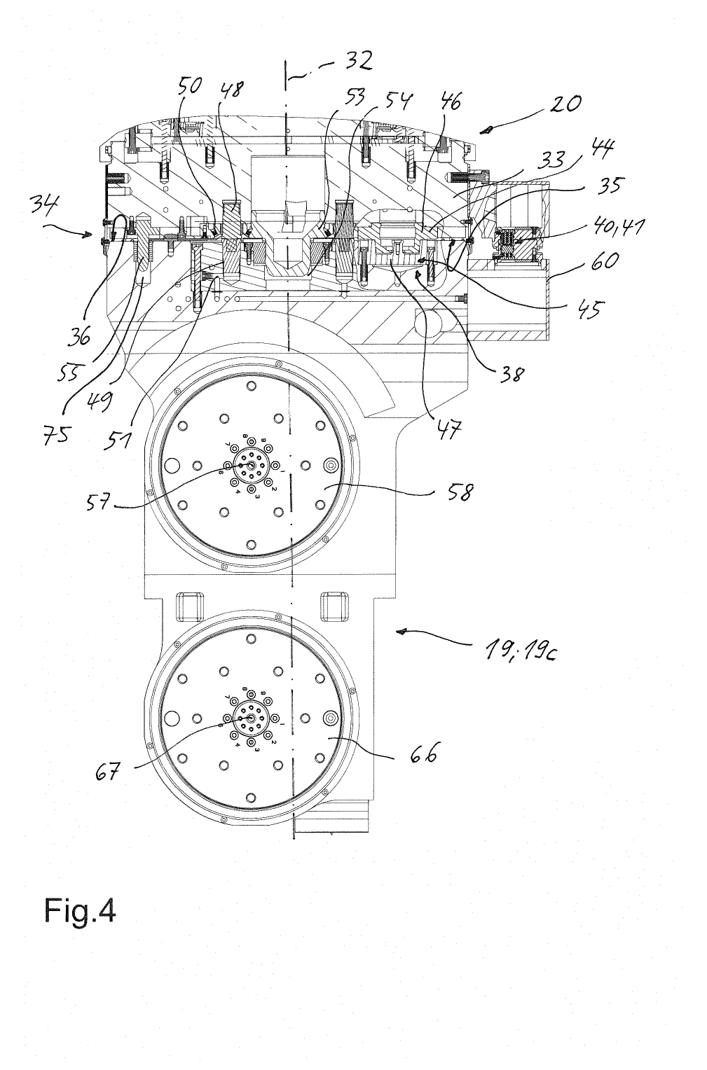

FIGS. 4-6 show a further embodiment of the workpiece module 19, which can be attached to the workpiece positioning unit 20 instead of the clamping device workpiece module 19a or the simple rotary table workpiece module 19b. In the exemplary case shown, the further embodiment is designed as a double rotary table workpiece module 19c.

This double rotary table workpiece module is characterized in that it has a further, second rotary table 66, which is rotatable about a third axis of rotation 67, in particular aligned parallel to the second axis of rotation 57.

As shown in particular in FIG. 6, a further, second clamping unit 68 for receiving and clamping a workpiece to be machined can be fastened to the second rotary table 66.

The double rotary table workpiece module allows for 5-axis machining of two workpieces 80, in particular similar workpieces, during a machining process, whereby the output of the machined workpieces 80 can be significantly increased.

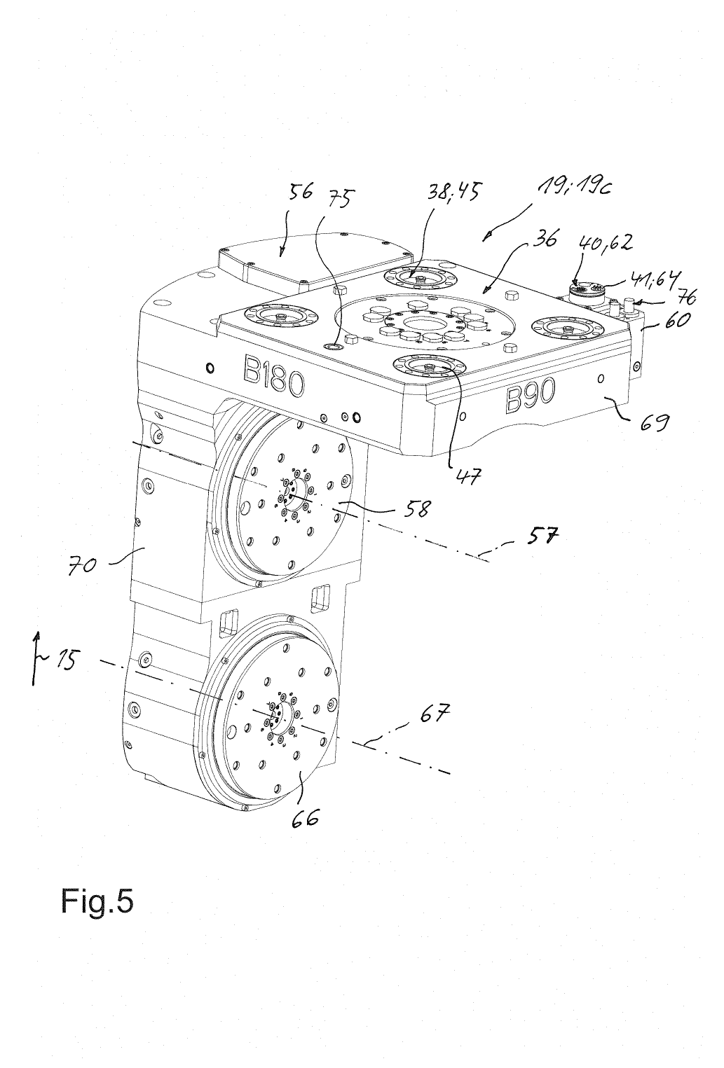

As further shown in FIG. 5, the double rotary table workpiece module 19c has an L-shaped configuration.

A plate-shaped counter-interface section 69 is provided, on which the components of the counter-interface 36 are formed in an identical manner to the previously described embodiments of the workpiece module 19, i.e., the fastening device 38, the fluid transfer device 39, the electric power transmission device 40, and the signal transfer device 41. A bearing section 70 is formed angularly to the plate-shaped counter-interface section 69, in particular protruding perpendicularly therefrom, on which the two rotary tables 58, 66 are arranged one above the other.

As already mentioned, the rotary drive 56 for generating the rotational movements of the rotary tables 58, 66 is on board the workpiece module, i.e., the double rotary table workpiece module 19c, wherein the drive movement for the rotary tables 58, 66 can be introduced via a gear not shown to the rotary tables 58, 66.

It should be mentioned once again that all described embodiments of the workpiece module 19, i.e., the clamping device workpiece module 19a, the simple rotary table workpiece module 19b, and the double rotary table workpiece module 19c, can be alternatively attached to the workpiece positioning unit 20, whereby a simple and quick conversion from 4-axis machining to 5-axis machining and vice versa is possible. This flexibility is made possible by the fact that the counter-interface 36 is constructed identically in all three different embodiments of the workpiece modules, so that they each fit the interface on the rotary table 33 of the workpiece positioning unit 20. Elaborate conversion work is therefore not necessary, but a simple "plug in" exchange of the workpiece modules is sufficient for conversion.

1. A machining center for the mechanical machining of workpieces, comprising:
at least one processing unit, which has a tool slide that can be equipped with a machining tool for machining a workpiece arranged in a machining zone, and
a workpiece positioning unit that can be equipped with a workpiece module for receiving the workpiece to be machined,
wherein the tool slide is movable in one axis direction and the workpiece positioning unit is movable in the two other axis directions of a Cartesian coordinate system formed by three mutually perpendicular axis directions X, Y, Z, and
wherein the workpiece module is rotatable about a first axis of rotation, wherein the workpiece module is releasably connected to the workpiece positioning unit via an interface device, allowing for an exchange of the workpiece module,
wherein the interface device has a workpiece-positioning-side interface and a corresponding module-side counter-interface,
wherein a fastening device for fastening the workpiece positioning unit and the workpiece module to each other is formed on the interface and the counter-interface, and
wherein a fluid transfer device for transferring a working fluid from the workpiece positioning unit to the workpiece module is formed on the interface and the counter-interface,
wherein an electric power transmission device for transferring electric power from the workpiece positioning unit to the workpiece module and a signal transfer device for enabling signal transmission between the workpiece positioning unit and the workpiece module are formed on the interface and the counter-interface.

2. The machining center according to claim 1, wherein the workpiece module is configured as a clamping device workpiece module for receiving and clamping the workpiece to be machined, wherein the clamping device workpiece module has clamping elements actuatable by means of the working fluid transferred via the interface device, for clamping the workpiece to be machined.

3. The machining center according to claim 1, wherein the workpiece module is configured as a rotary table workpiece module, with at least one rotary table, rotatable by means of an electric rotary drive about a second axis of rotation to which a clamping unit for receiving and clamping a workpiece to be machined can be fastened, wherein the electric rotary drive is on board the rotary table workpiece module and the electric power for the rotary drive can be introduced via the interface device.

4. The machining center according to claim 3, wherein the rotary table workpiece module has an additional, further second rotary table, which is rotatable about a third axis of rotation to which a second clamping unit for receiving and clamping a workpiece to be machined can be fastened.

5. The machining center according to claim 4, wherein the rotary drive is configured to drive both rotary tables.

6. The machining center according to claim 3, wherein a position detection device for detecting the rotational position of the assigned rotary table is assigned to the workpiece module wherein the position detection device has at least one position detector located on board the workpiece module whose detector signals are transmitted via the interface device.

7. The machining center according to claim 1, wherein the fastening device has fastening elements formed on the interface and counter-fastening elements formed on the counter-interface, which can be brought into engagement with each other for fastening the workpiece module to the workpiece positioning unit and out of engagement with each other for releasing the workpiece module.

8. The machining center according to claim 7, wherein the fastening elements and/or counter-fastening elements are mounted relatively movable to the associated interface or counter-interface via clamping means between a clamping position and a release position releasing the workpiece module.

9. The machining center according to claim 1, wherein the electric power transmission device is configured as an electromechanical plug connection device, with an electrical circular connector for plugging into an electrical counterpart and the electrical counterpart.

10. The machining center according to claim 9, wherein
the signal transfer device is configured as a further electromechanical plug connection device, with an electrical signal circular connector for plugging into an electrical signal counterpart and the electrical signal counterpart.

11. The machining center according to claim 1, wherein the interface is formed on the underside of a rotary table arranged on the workpiece positioning unit and rotationally drivable about the first axis of rotation.

12. The machining center according to claim 1, wherein the interface on the underside of the rotary table is rectangular.

13. The machining center according to claim 1, wherein the counter-interface is formed on an rectangular counter-interface plate or on a plate-shaped counter-interface section.

14. A machining center for the mechanical machining of workpieces, comprising:
at least one processing unit, which has a tool slide that can be equipped with a machining tool for machining a workpiece arranged in a machining zone, and
a workpiece positioning unit that can be equipped with a workpiece module for receiving the workpiece to be machined,
wherein the tool slide is movable in one axis direction and the workpiece positioning unit is movable in the two other axis directions of a Cartesian coordinate system formed by three mutually perpendicular axis directions X, Y, Z, and wherein the workpiece module is rotatable about a first axis of rotation, wherein the workpiece module is releasably connected to the workpiece positioning unit via an interface device, allowing for an exchange of the workpiece module, wherein the interface device has a workpiece-positioning-side interface and a corresponding module-side counter-interface, wherein the workpiece module is selected from the group consisting of a clamping device workpiece module having the counter-interface for receiving and clamping the workpiece, wherein the clamping device workpiece module has clamping elements actuatable by means of working fluid for clamping the workpiece to be machined, and a rotary table workpiece module having the counter-interface, with at least one rotary table rotatable by means of an electric rotary drive about a second axis of rotation, to which a clamping unit for receiving and clamping a workpiece to be machined can be fastened, wherein optionally the clamping device workpiece module or the rotary table workpiece module can be fastened to the workpiece positioning unit via the interface device.

15. The machining center according to claim 14, wherein the rotary table workpiece module is either a rotary table workpiece module with a single rotary table or a double rotary table workpiece module with a first and a second rotary table rotationally drivable about a third axis of rotation.
